(19) United States
(12) Patent Application Publication
(10) Pub. No.: US 2025/0283746 A1
(43) Pub. Date: Sep. 11, 2025

(54) SYSTEM FOR MEASURING TANK CONTENTS AND METHOD

(71) Applicant: Spearhead Design Inc., Olds (CA)

(72) Inventors: Monte HINDBO, Olds (CA); Shea LAYDEN, Olds (CA)

(21) Appl. No.: 19/071,313

(22) Filed: Mar. 5, 2025

Related U.S. Application Data
(60) Provisional application No. 63/561,342, filed on Mar. 5, 2024.

(51) Int. Cl. G01F 22/00; B65D 88/26; B65D 90/48

(52) U.S. Cl. CPC G01F 22/00; B65D 90/48; B65D 88/26

(57) ABSTRACT

The system comprises: a tank having: an interior boundary; an upper portion defining a portion of the interior boundary and having an intake aperture for receiving the gravity flow; a lower portion defining a portion of the interior boundary and having a discharge aperture; and a vertical axis; and one or more devices disposed adapted to generate data representative of the elevation of the surface of any granular material in the tank, the data including data from a plurality of locations which substantially span the distance between the axis and the boundary at its widest point.

### CROSS REFERENCE TO RELATED APPLICATIONS

This application claims priority to U.S. Provisional Application Ser. No. 63/561,342, filed Mar. 5, 2024.

### FIELD

The invention relates to the field of hydraulic fracturing.

### BACKGROUND

Hydraulic fracturing is a method of extracting oil and natural gas from underground rock formations. It involves injecting a mixture of water, sand and chemicals into a well at high pressure. Significant amounts of sand are consumed, and if an operation runs out of sand, the costs of lost production can be significant. However, since sand does not self-level like water, it is difficult to maintain levels on hand, and thus difficult to ensure that inventory is adequate.

### SUMMARY

Forming one aspect of the invention is a system for use with an intermittent gravity flow of granular material. This system comprises: a tank having: an interior boundary; an upper portion defining a portion of the interior boundary and having an intake aperture for receiving the gravity flow; a lower portion defining a portion of the interior boundary and having a discharge aperture; and a vertical axis; and one or more devices disposed adapted to generate data representative of the elevation of the surface of any granular material in the tank, the data including data from a plurality of locations which substantially span the distance between the axis and the boundary at its widest point.

Forming another aspect of the invention is a method for use with the system, the method comprising: receiving, from the one or more devices, the data; determining a plurality of volumes, wherein: each volume is associated with one of a plurality of predetermined notional cylinders; each of the predetermined notional cylinders is associated with a respective portion of the locations; and each of the plurality of volumes is a function of the elevation(s) of the location(s) with which the cylinder is associated; and aggregating the volumes to calculate a volume of granular material in the tank.

According to another aspect of the invention, in the system: the one or more devices can measure distance; the locations of the plurality can be aligned in a plane that is coincident with the axis; the lower portion can be or comprise a funnel leading to the discharge aperture; the axis can intersect the intake aperture and the discharge aperture; the tank can be annular and is coaxial with the axis; the tank can be a sand tank; the lower portion can be frustoconical and the tank can have a cylindrical intermediate portion between the upper portion and the lower portion; the tank can be configured for funnel flow; the one or more devices can be in the upper portion; a plurality of devices can define the one or more devices; and each device of the plurality of devices can be a depth sensor that measures the distance to the surface beneath it.

This system can be used in a method which forms another aspect of the invention. This method comprises:
receiving, from the one or more devices, the data;
determining a plurality of volumes, wherein:
   each volume is associated with one of a plurality of predetermined notional cylinders;
   each of the predetermined notional cylinders is associated with a respective portion of the locations; and
   each of the plurality of volumes is a function of the diameter of the one of the plurality of predetermined notional cylinders to which it is associated, the diameter of the next smaller cylinder, if any, and the depth(s) of the granular material at the location(s); and
aggregating the volumes to calculate a volume of granular material in the tank.

Advantages, features and characteristics of the invention will become understood upon review of the following detailed description with reference to the appended drawings, the latter being hereinafter briefly described.

### BRIEF DESCRIPTION OF THE DRAWINGS

In the drawings:

FIG. 1 is a schematic view of an example embodiment of the invention

FIG. 2 is a top view of the structure of FIG. 1

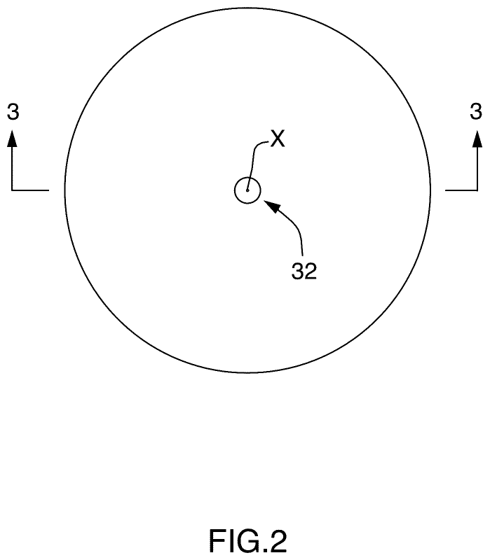

FIG. 3 is a view along 3-3 of FIG. 2

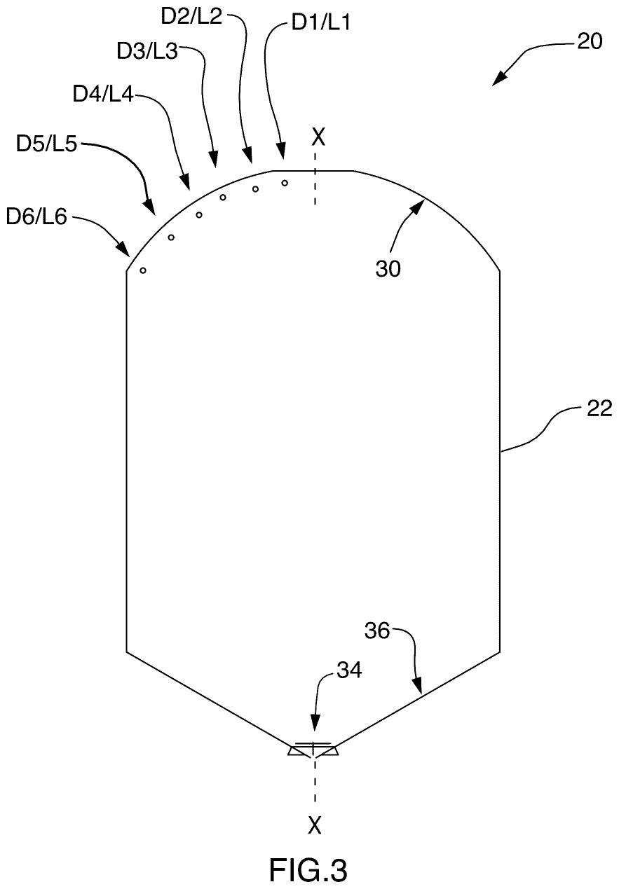

FIG. 4 is a top view of the structure of FIG. 3

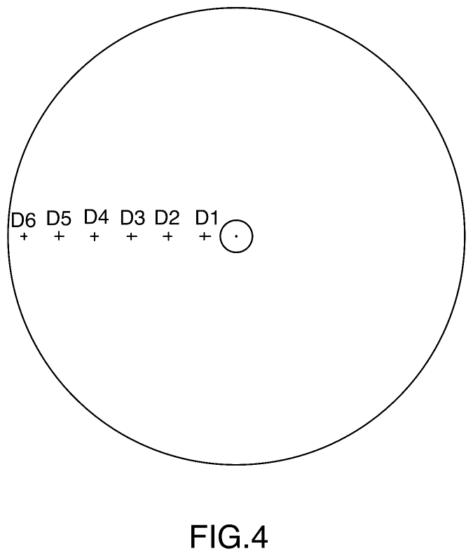

FIG. 5 is a view similar to FIG. 4 showing details of a calculation according to an example embodiment of the inventive method

FIG. 6 is a view similar to FIG. 3 showing further details of the calculation

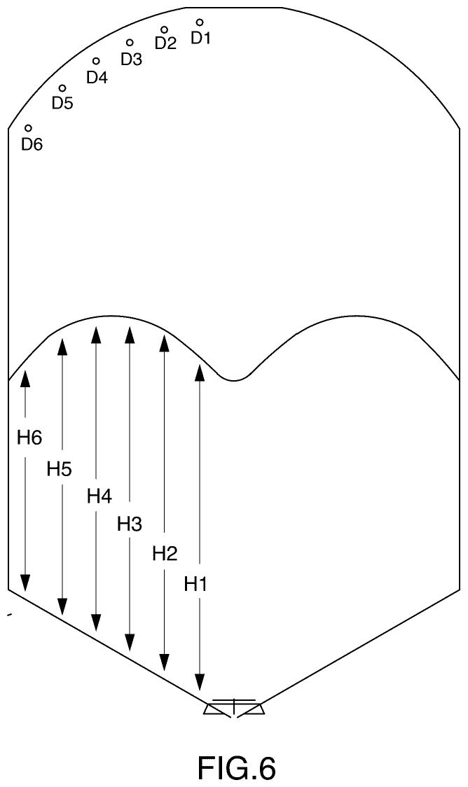

FIG. 7 is another view showing yet further details of the calculation.

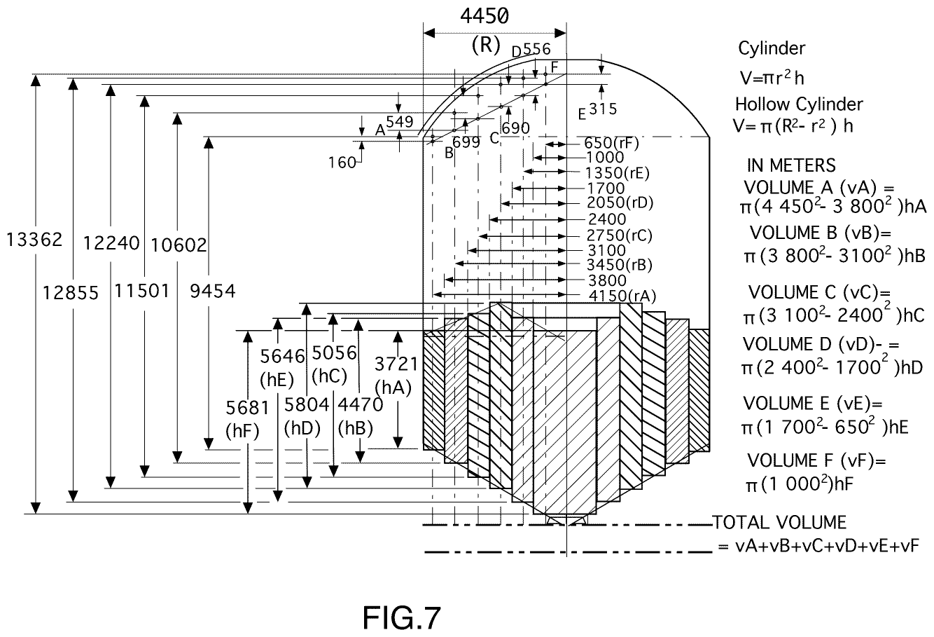

### DETAILED DESCRIPTION

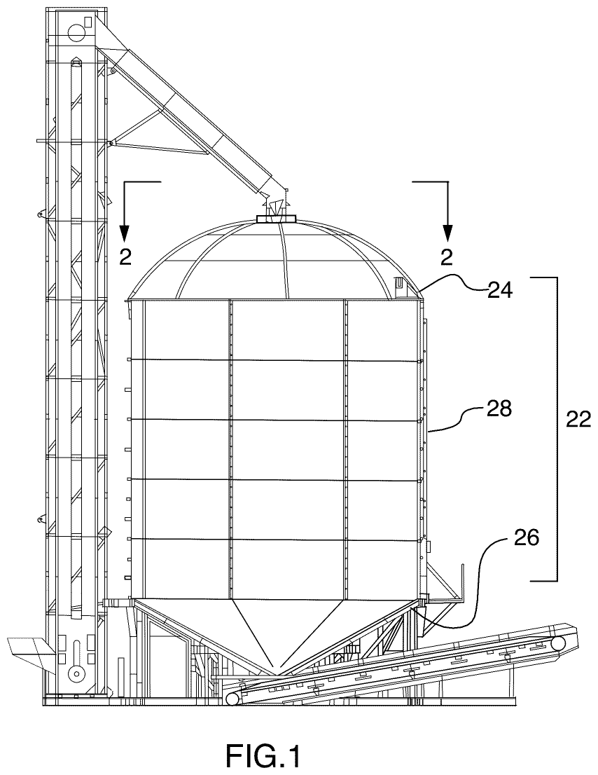

A system 20 according to an example embodiment of the invention is shown in schematic in FIG. 1.

As an initial matter, it will be understood that the system is for use with an intermittent gravity flow of granular material, i.e. the flow from a sand elevator spout that is periodically activated and deactivated.

The system itself comprises a tank 22 and one or more devices D1-D6.

The tank is an annular sand tank configured for funnel flow, has a vertical axis X-X and has an upper portion 24, a lower portion 26 and an intermediate portion 28, collectively defining an interior boundary of the tank 30.

The upper portion has an intake aperture 32 for receiving the gravity flow which is intersected by the vertical axis.

The lower portion has a discharge aperture 34 which is intersected by the vertical axis and further has a frustoconical funnel 36 leading to the discharge aperture.

The intermediate portion is cylindrical and extends between the upper portion and the lower portion.

The one or more devices are adapted to generate data representative of the elevation of the surface of any granular material in the tank, the data including data from a plurality of locations L1-L6 which substantially span the distance between the axis and the boundary at its widest point.

More particularly:
the one or more devices measure distance;
the locations L1-L6 of the plurality are aligned in a plane that is coincident with the axis;
the one or more devices are in the upper portion;
a plurality of devices define the one or more devices; and
each device of the plurality of devices is a depth sensor that measures the distance to the surface beneath it and is placed at a known distance to the surface of the tank immediately therebeneath, i.e. forming part of the interior boundary.

The system of the invention can be used in a method which forms another aspect of the invention.

An example method according to the invention leveraging the example system is described hereinbelow.

As an initial matter, it will be appreciated that the method involves the concept of notional cylinders each coaxial with the tank axis, associated with a respective location and equidistant to the location to which it is associated and the location to which the next larger cylinder, if any, is located. It will be appreciated that notional cylinders C1-C6 each have an associated radius R1-R6.

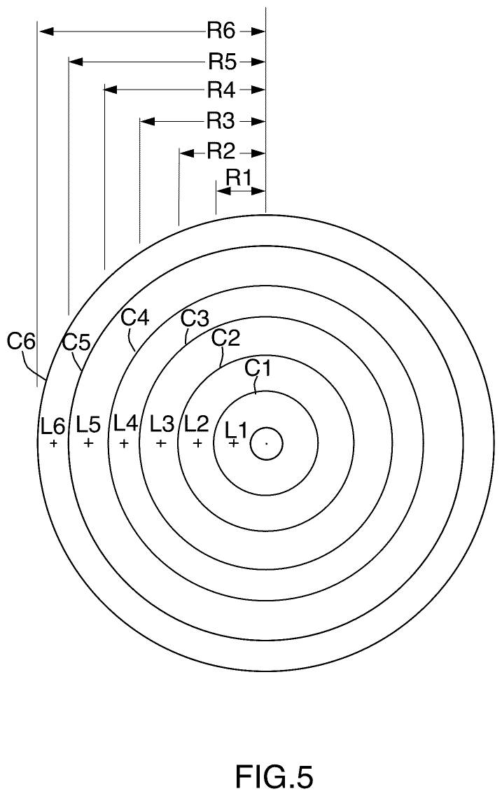

This is shown in FIG. 5.

An initial step of the method involves receiving, from the one or more devices, the data representative of the elevation of the surface of any granular material in the tank. In this regard, it will be understood that, as each of the devices is positioned at a known distance from the interior surface of the tank below, and is adapted to measure the distance to the surface immediately below, the depth of the granular material beneath said each device is easily calculated as the known distance less the measured distance, i.e. the devices easily allow the calculation of a series of sand depths, H1 through H6, each associated with and generated by a respective one of devices D1 through D6.

The next step involves the calculation of a plurality of volumes, each being defined by:
the volume of a cylinder having the diameter of the one of the plurality of predetermined notional cylinders to which said each of the volumes is associated and the depth of the sand, if any, at the location to which the predetermined cylinder is associated
less
the volume of a cylinder having the diameter of the next smaller one of the plurality of predetermined notional cylinders, if any, and the depth of the sand, if any, at the location to which the predetermined cylinder is associated, i.e.

V6=πR6²H6−πR5²H6

V5=πR5²H5−πR4²H5

V4=πR4²H4−πR3²H4

V3=πR3²H3−πR2²H3

V2=πR2²H2−πR1²H2

V1=πR1²H1

Thereafter the volume of the sand in the tank is calculated as the sum of the volumes, i.e. V6+V5+V4+V3+V2+V1

The method can be used to advantage in an inventory management method that forms another aspect of the invention.

In this regard, it will be understood by persons of ordinary skill in the art that, in the field of fracking, field operators call for sand deliveries by the ton and purchase sand by the ton. Sand is typically stored near the fracking site in tanks and delivered to and from the tanks by dump trunk.

Tonnage delivered to the tanks is often calculated based upon tare weight at scales at or near the pit. Tonnage delivered from the tanks is normally calculated based upon dump volume since, due to the remote and transient nature of fracking sites, scales are rarely available. Uncertainty is introduced throughout the process: trucks lose sand during transport; sand density varies naturally, and with moisture content; and loads get hung up, inter alia, in freezing conditions.

The invention derives from the insight that the desired function of inventory management at the field level is largely a desire for predictability rather than precision.

To this end, a modification to the delivery calculation that improves predictability, notwithstanding that it may not improve precision, has utility.

For this purpose, calculations can be made as follows:

$$average tank density post load is : average tank density pre - \text{} load \times pre - load tank volume + \frac{tare weight of load from dump}{total volume in tank after load}$$

$$tonnage of delivered load is : volume \text{} of load delivered \times average tank density pre - load$$

Whereas specific embodiments are herein shown and described, variations are possible.

Accordingly, the invention should be understood to be limited only by the accompanying claims, purposively construed.

Without limitation in this regard:
the sensors need not be disposed in a common plane
redundant sensors could be provided
the sensors need not be equidistant between the boundaries of the notional cylinders
more complex maths could be utilized to approximate the volume of the granular material, for example, the sloped floor of the funnel could be taken into account, and regression analysis could be utilized to approximate slopes of the granular surface
the inlet and outlet need not be axially spaced apart
the system and method could be employed for tanks configured for mass flow

Accordingly, the invention should be understood to be limited only by the accompanying claims, purposively construed.

1. A system for use with an intermittent gravity flow of granular material, the system comprising:
a tank having: an interior boundary; an upper portion defining a portion of the interior boundary and having an intake aperture for receiving the gravity flow; a lower portion defining a portion of the interior boundary and having a discharge aperture; and a vertical axis; and
one or more devices disposed adapted to generate data representative of the elevation of the surface of any granular material in the tank, the data including data from a plurality of locations which substantially span the distance between the axis and the boundary at its widest point.

2. A system according to claim 1, wherein the one or more devices measure distance.

3. A system according to claim 1, wherein the locations of the plurality are aligned in a plane that is coincident with the axis.

4. A system according to claim 1, wherein the lower portion is or comprises a funnel leading to the discharge aperture.

5. A system according to claim 1, wherein the axis intersects the intake aperture and the discharge aperture.

6. A system according to claim 1, wherein the tank is annular and is coaxial with the axis.

7. A system according to claim 1, wherein the tank is a sand tank.

8. A system according to claim 1, wherein the lower portion is frustoconical and the tank has a cylindrical intermediate portion between the upper portion and the lower portion.

9. A system according to claim 1, wherein the tank is configured for funnel flow.

10. A system according to claim 1, wherein the one or more devices are in the upper portion.

11. A system according to claim 1, wherein a plurality of devices define the one or more devices.

12. A system according to claim 11, wherein each device of the plurality of devices is a depth sensor that measures the distance to the surface beneath it.

13. A system according to claim 1, wherein: the one or more devices measure distance; the locations of the plurality are aligned in a plane that is coincident with the axis; the lower portion is or comprises a funnel leading to the discharge aperture; the axis intersects the intake aperture and the discharge aperture; the tank is annular and is coaxial with the axis; the tank is a sand tank; the lower portion is frustoconical and the tank has a cylindrical intermediate portion between the upper portion and the lower portion; the tank is configured for funnel flow; the one or more devices are in the upper portion; a plurality of devices define the one or more devices; and each device of the plurality of devices is a depth sensor that measures the distance to the surface beneath it.

14. A method for use with a system according to claim 1, the method comprising:
receiving, from the one or more devices, the data;
determining a plurality of volumes, wherein:
each volume is associated with one of a plurality of predetermined notional cylinders;
each of the predetermined notional cylinders is associated with a respective portion of the locations; and
each of the plurality of volumes is a function of the elevation(s) of the location(s) with which the cylinder is associated; and
aggregating the volumes to calculate a volume of granular material in the tank.

15. The method of claim 14, wherein each volume is a function of the diameter of the one of the plurality of predetermined notional cylinders with which it is associated and a function of the diameter of the next smaller cylinder, if any.

16. The method of claim 14, wherein each volume is a function of the diameter of the one of the plurality of predetermined notional cylinders to which it is associated, the diameter of the next smaller cylinder, if any, and the depth(s) of the granular material at the location(s).

17. A method for use with a system according to claim 13, the method comprising:
receiving, from the one or more devices, the data;
determining a plurality of volumes, wherein:
each volume is associated with one of a plurality of predetermined notional cylinders;
each of the predetermined notional cylinders is associated with a respective portion of the locations; and
each of the plurality of volumes is a function of the diameter of the one of the plurality of predetermined notional cylinders to which it is associated, the diameter of the next smaller cylinder, if any, and the depth(s) of the granular material at the location(s); and
aggregating the volumes to calculate a volume of granular material in the tank.

18. A method according to claim 17, wherein each of the devices is positioned at a known distance from the interior surface of the tank below and the depth of the granular material beneath said each device is defined by the distance less the measured distance.

19. A method according to claim 17, wherein each of the predetermined notional cylinders is equidistant to the location to which it is associated and the location to which the next larger cylinder, if any, is located.

20. A method according to claim 17, wherein each of the plurality of volumes is defined by:
the volume of a cylinder having the diameter of the one of the plurality of predetermined notional cylinders to which said each of the volumes is associated and the depth of the sand, if any, at the location to which the predetermined cylinder is associated
less
the volume of a cylinder having the diameter of the next smaller one of the plurality of predetermined notional cylinders, if any, and the depth of said, if any, at the location to which said next smaller predetermined cylinder is associated.
